(19) United States
(12) Patent Application Publication
(10) Pub. No.: US 2007/0292630 A1
(43) Pub. Date: Dec. 20, 2007

(54) Method And Apparatus For Heating A Gas Stream

(75) Inventors: Jacek Tadeusz Gabzdyl, Guildford (GB); Andrew Johnson, Wokingham (GB)

Correspondence Address: THE BOC GROUP, INC., 575 MOUNTAIN AVENUE, MURRAY HILL, NJ, 07974-2064, US

(73) Assignee: THE BOC GROUP PLC, Windlesham (GB)

(21) Appl. No.: 11/630,306

(22) PCT Filed: Jun. 23, 2005
(86) PCT No.: PCT/GB05/02491

§ 371 Date: Mar. 16, 2007

(30) Foreign Application Priority Data
Jun. 30, 2004 (GB) 0414680.9

(51) Int. Cl. H05H 1/24

(52) U.S. Cl. 427/569; 219/121.47

(57) ABSTRACT

A product stream of hot gas is formed at elevated pressure. A primary gas stream is passed at elevated pressure through a flow control valve in a primary gas stream inlet to a plasma generator. The plasma generator is operated so as to heat the primary gas stream. The heated primary gas stream passes into a gas mixing chamber. A secondary gas stream passes through a flow control valve into the gas mixing chamber. A product gas stream leaves the gas mixing chamber. The temperature of the product gas stream is sensed. One or both of the flow valves and/or the operating power of the plasma generator may be used or adjusted to control the temperature of the product gas stream.

### CROSS-REFERENCE TO RELATED APPLICATIONS

National Stage Application of International Application No. PCT/GB2005/002491 filed Jun. 23, 2005, (published as WO 2006/003374) which claims priority to British Application No. GB 0414680.9 filed Jun. 30, 2004.

### BACKGROUND OF THE INVENTION

This invention relates to a method and apparatus for heating a gas stream at elevated pressure.

Hot gas streams are used in a number of different industrial processes. One example of a process in which a hot gas stream is used is the so-called “cold gas-dynamic spraying” process according to U.S. Pat. No. 5,302,414. This process is used to coat a substrate by spraying at the substrate a particulate material which is carried in a preheated gas stream. The residence time of the particles in the gas stream and the temperature of the gas stream are such that the particulate material does not melt before its impact with the substrate. In this respect, cold gas-dynamic spraying is different from other thermal spraying processes, such as plasma-arc spraying, which rely on preheating the particulate material to a temperature substantially above its melting point before its impact with the substrate. Cold gas-dynamic spraying is believed to offer a number of advantages over other, higher temperature, thermal spraying methods, particularly in terms of the microscopic structure of the resultant coating.

It has been found in commercial use that it is desirable to effect rapid changes in the temperature of the gas into which the particulate material to be sprayed is fed. Conventional electrical heaters, be they in the form of coil heaters or filament heaters, are found to be slow.

### BRIEF SUMMARY OF THE INVENTION

It is an aim of the present invention to provide an apparatus and method for heating a gas stream which is capable of ameliorating the disadvantages associated with the abovementioned electrical heaters.

According to the present invention there is provided apparatus for forming a product stream of hot gas at elevated pressure, comprising a plasma generator having an inlet for a primary gas stream at elevated pressure and an outlet for a resulting heated primary gas stream at elevated pressure, a gas mixing chamber for mixing the heated primary gas stream at elevated pressure with a secondary gas stream so as to form the product gas stream of hot gas at elevated pressure, a temperature controller for controlling the temperature of the said product stream, and a temperature sensor operatively associated with the temperature controller.

The invention also provides a method of forming a product stream of hot gas at elevated pressure, comprising passing a primary gas stream at elevated pressure through a plasma generator, operating the plasma generator so as to heat the primary gas stream, mixing the heated primary gas stream with a secondary gas stream so as to form the product stream of hot gas at elevated pressure, and controlling the temperature of the said product stream.

The apparatus and method according to the invention are capable of operation so as to enable the product gas stream to be produced at any selected temperature within a wide range of temperatures and to enable the selected temperature to be rapidly changed to a different temperature.

Preferably, if, for example, the product gas stream is to be used in a cold gas dynamic spraying process it is produced at a selected temperature in the range of 200° C. to 800° C.

The plasma generator may be of the direct current, microwave or radio frequency kind.

The primary gas stream may be composed of any gas or gas mixture which is able to sustain stable plasma in the plasma generator at a selected operating pressure. Suitable gases include nitrogen, hydrogen, argon and helium (or other noble gas) or mixtures of any two or more of these gases.

The method and apparatus according to the present invention may be used to produce the product gas stream at any convenient superatmospheric pressure, for example, one that makes the product gas stream suitable for use is cold gas dynamic spraying. Accordingly, the outlet pressure of the cooling chamber may be in the range of 1.1 bar to 30 bar. The plasma gas stream and the secondary gas stream also be supplied at pressures in this range.

Preferably the mixing chamber has a cooling jacket and is typically water-cooled.

The plasma generator may be located outside or within the mixing chamber.

The secondary gas stream may have the same composition as the primary gas stream or be of a different composition.

The secondary gas stream is preferably introduced into the mixing chamber at a temperature in the range of 0° C. to 50° C.

The mixing chamber is preferably less than 1 m in length and is typically as short as possible.

The temperature controller preferably comprises a flow control valve for varying the flow rate of the secondary gas stream and/or the flow rate of the primary gas stream. In one preferred arrangement, the primary gas stream and the secondary gas stream come from a common source and a flow control valve is operable to select the relative flow rates of the primary gas stream and the secondary gas stream.

Temperature control may additionally or alternatively be exerted by varying the plasma generator power.

The temperature sensor is preferably located in or near to the outlet of the mixing chamber or at a more downstream location, for example at the point of use. A preferred arrangement is one in which a flow control valve controlling the flow rate of the secondary gas stream is adjusted to the plasma generator and/or the flow rate of the cooling gas is adjusted so as to keep the sensed temperature at a selected temperature (set point) (or between chosen temperature limits). Most preferably the set point is adjustable, for example, between 200° C. to 800° C. An advantage of such an example of the method and apparatus according to the invention is that if the set point is changed, the response time is rapid, typically being a matter of seconds only. In an additional or alternative arrangement the temperature sensor controls the power to the plasma generator or the position of a flow control valve in an inlet to the plasma generator.

Particularly preferred control systems for use in the method and apparatus according to the invention also employ a pressure sensor and adjust the pressure of the gas stream and the cooling gas so as to maintain a chosen pressure at the outlet of the mixing chamber or a position downstream thereof.

### BRIEF DESCRIPTION OF THE DRAWINGS

The method and apparatus according to the invention will now be described by way of example with reference to the accompanying drawings, in which:

FIG. 1 is a schematic side elevation, partly in section, of a plasma gas heater according to the invention;

FIG. 2 is a schematic diagram illustrating a temperature and pressure control system for use with the plasma gas heater shown in FIG. 1; and

FIG. 3 is a graph of temperature against time for operation of an apparatus similar to that shown in FIG. 1.

### DETAILED DESCRIPTION OF THE INVENTION

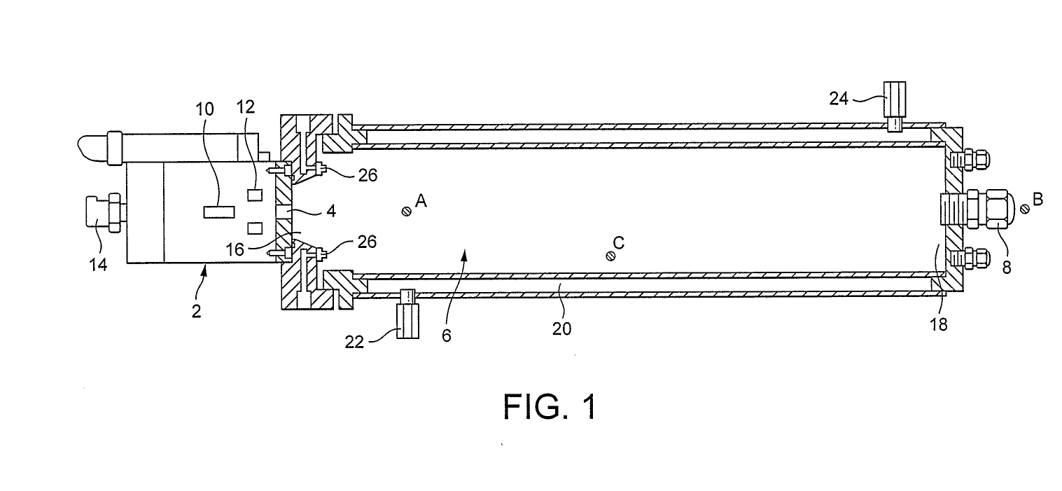

Referring to FIG. 1 of the drawings, a plasma gas heater according to the invention comprises a DC plasma generator 2 which has an outlet 4 for a hot primary gas stream communicating directly with the proximal end 16 of an elongate mixing chamber 6 having an outlet 8 at its distal end 18 for a product hot gas stream at a chosen temperature. The product hot gas stream passes to any apparatus in which it may usefully be employed. For example, it may be passed to a cold gas dynamic spraying apparatus of the kind disclosed in U.S. Pat. No. 5,302,414.

The plasma generator 2 typically comprises a tungsten cathode 10 and a copper anode 12, both of which are water cooled. Plasma gas (typically argon, nitrogen, hydrogen or helium, or a mixture of any two or more of these gases) at elevated pressure flows around the cathode 10 and through the anode 12 which is typically shaped as a constricting nozzle. A plasma is a gas that has been heated to a sufficiently high temperature to become partially ionised and therefore electrically conductive. The plasma is initiated by a high voltage discharge which causes localised ionisation and a conductive path for a DC arc to form between the cathode 10 and the anode 12. If desired a high tension spark may be used to initiate the plasma. Alternatively, the plasma may be initiated at atmospheric pressure and the pressure then raised. The gap between the electrodes can be varied to help initiation of the plasma. A narrow gap favours initiation at low pressure. Once the plasma has been successfully initiated it is normally quite stable. The resistance from the arc causes the gas to reach a very high temperature, dissociate and ionise to form the plasma. The plasma passes through the anode 12 and the outlet 4 to the mixing chamber 6 as a free or neutral plasma flame. Alternatively, the plasma generator 2 may be of a microwave or radio frequency kind.

The plasma generator 2 has an inlet 14 for the primary gas stream in which the plasma is formed. The inlet 14 is located remote from the outlet 4. The primary gas stream may be supplied to the inlet 14 under pressure from a source of pressurised gas, for example a gas cylinder. Typically, the plasma gas is supplied to the inlet 14 at a pressure in the range of 1.1 to 30 bar.

The length of the chamber 6 is typically well below 1 meter in length. The chamber 6 is generally right cylindrical in form. In operation, it may be disposed with its longitudinal axis horizontal, although it may be employed in other orientations, particularly a vertical orientation. The path of the gas from the proximal end 16 to the distal end 18 is typically unobstructed. If desired, a static mixing device (not shown) may be located in the chamber 6 so as to increase mixing between the primary gas stream and the secondary gas stream.

The mixing chamber 6 is surrounded by a jacket 20 for the flow of coolant, typically a liquid such as water. The jacket has an inlet 22 for the coolant near the proximal end 16 of the chamber 6 and an outlet 24 for the coolant near the distal end 18 of the chamber 6.

The mixing chamber 6 also has one or more secondary inlets 26 for the flow of the secondary gas stream. The secondary inlets 26 are located near the proximal end 16 of the chamber 4. The secondary inlets may be arranged so as to give a generally axial flow of the secondary gas. (Alternatively, the secondary inlets 26 may be tangentially arranged so as to give a swirling flow of the cooling gas.) Typically, there are several circumferentially disposed secondary inlets 26, all equally spaced from one another. Alternatively, an annular inlet for the secondary gas stream may be employed.

If desired, the secondary gas stream may have the same composition as the primary gas stream and may be taken from the same source. The secondary gas stream is sometimes but not necessarily supplied at a lower pressure than the gas from which the plasma is formed.

The secondary gas stream is typically supplied at ambient temperature or any other temperature less than 100° C.

Irrespective of whether coolant is passed through the cooling jacket 20 the mixing of the heated primary gas stream with the secondary gas stream reduces its temperature as it flows from the proximal end 16 to the distal end 18 of the chamber 6. Preferably the outlet temperature of the resulting product gas stream is in the range of 200 to 800° C. Such temperatures are, for example, suitable in cold gas dynamic spraying processes. Various techniques may be used to control the temperature of the gas at the outlet. Typically, the flow rate and/or composition of the secondary gas stream introduced into the cooling chamber 6 through the secondary inlets 26 is controlled. Alternatively or additionally, the flow rate and composition of the primary gas may be controlled. Further control may be exerted through varying the power fed to the plasma generator 2.

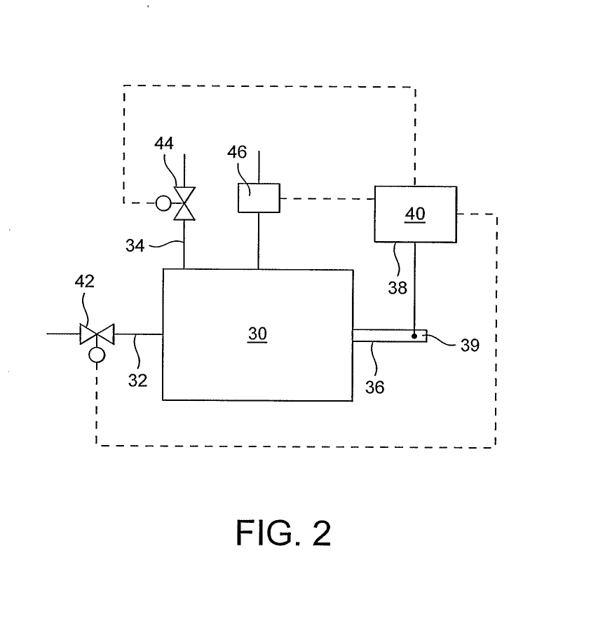

A suitable control means is shown in FIG. 2. Referring to FIG. 2, a gas heating apparatus 30 according to the invention has an inlet 32 for a primary gas stream, an inlet 34 to the mixing chamber for a secondary gas stream and an outlet 36 for the heated product gas stream. The arrangement of the apparatus 30 may be that of the apparatus shown in FIG. 1. A temperature sensor 38 and a pressure sensor 39 are located in the outlet 36 (or at a downstream location). Both generate electrical signals representative of, respectively, the temperature and the pressure of the gas produced by the method according to the invention. These signals are fed to a programmable process controller 40 of a kind well known in the art which may operate to adjust the position of flow control valves 42 and 44 in the inlets 32 and 34, respectively, and a device 46 which controls the operating current or voltage (or both) and hence the operating power of the plasma generator 2. The arrangement is such so as to maintain the temperature and pressure of the product gas stream in the outlet 36 relatively constant or between chosen limits.

Various tests of the method and apparatus according to the invention have been performed. The standard operating parameters for the tests were that the plasma generator 2 had a current of 160 A and a voltage of between 32 and 36 volts; argon was supplied as the primary gas stream to the plasma generator 2 at a pressure of 90 psig. Argon was supplied as a secondary gas stream to the mixing chamber 6 at a pressure of 2 bar. Temperatures were continuously measured in four positions, A to C. Position A was on the longitudinal axis of the chamber 4 at a distance of 50 mm from the proximal end 16, position B was in the outlet 8 of the mixing chamber 6, and position C was in the chamber 6 10 mm from the chamber wall and 280 mm from its proximal end 16. The total length of the chamber 6 was about 500 mm.

In performing the experiments a stabilised source of voltage was not used. There were continuous small fluctuations in the voltage between 32 and 36 volts. The temperatures measured by thermocouples at the positions A to C thus tended continuously to fluctuate. If a stabilised source of voltage had been used, these voltage fluctuations would have been reduced. Even without voltage stabilisation, the extent of the fluctuations was less than in conventional electrical heaters and within the bounds of operational acceptability for cold gas dynamic spraying.

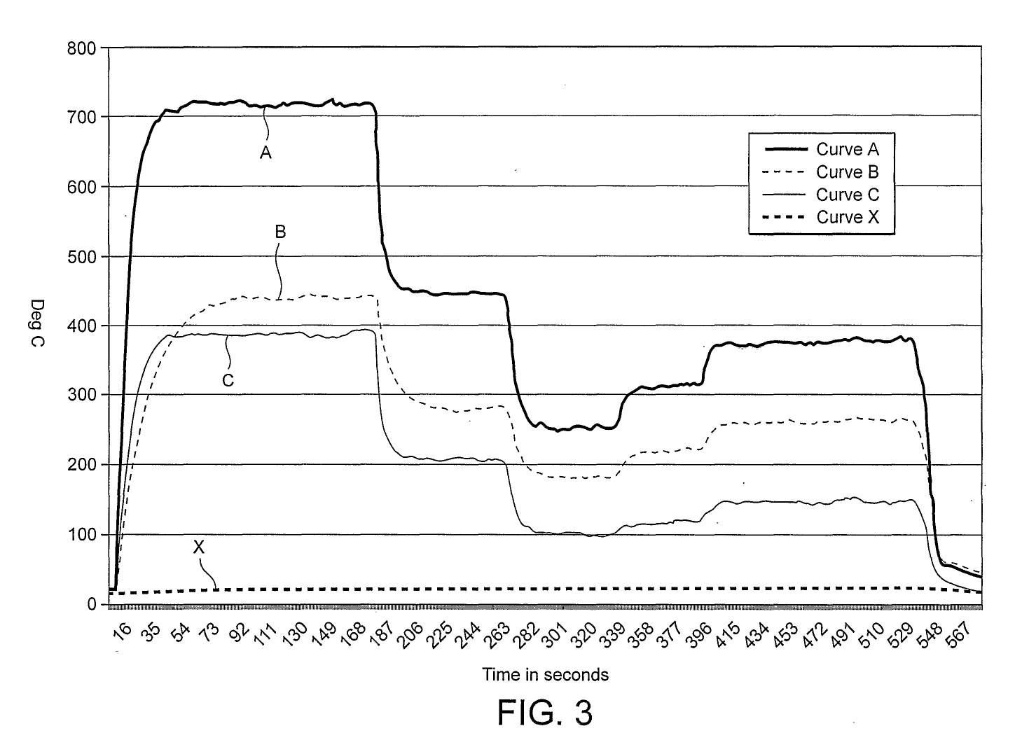

The results obtained from tests under the above conditions are shown in FIG. 3. In FIG. 3 the temperatures at positions A, B and C were continuously measured. In addition, the exit temperature of the cooling water was measured. This is shown by curve X in FIG. 3. In obtaining the results shown in FIG. 3, the initial operating pressure of the mixing chamber 6 was 1.5 bar.

The results show that within 90 seconds from starting from cold an essentially stable outlet temperature of between 400 and 500° C. was achieved in the product gas stream. This result was achieved without the supply of any secondary gas to the mixing chamber 6. At a time, t, of approximately 180 seconds a secondary gas supply of helium was initiated. The operating pressure of the mixing chamber 6 was increased to 2 bar. The outlet temperature of the product gas stream fell within a matter of seconds to a stable temperature a little below 300° C. This shows that the supply of the secondary gas stream can be used to control dynamically the outlet temperature of the cooling chamber 4. At time t approximately equal to 273 seconds the rate of supply of secondary gas was increased by 50% and the operating pressure of the mixing chamber 6 was increased from 2 bar to 2.7 bar. This resulted in a further fall in the product gas outlet temperature to below 200° C. At time t equal to 339 seconds the plasma generator current was increased to 200 A. The product gas temperature rose to above 200° C. At time t of 396 seconds the plasma gun current was increased to 250 A. This resulted in another increase in the outlet temperature of the product gas by an amount in the order of 30 to 40° C., and shows that varying the power fed to the plasma generator 2 enables the temperature of the gas to be controlled dynamically. At time, t, equal to approximately 540 seconds the plasma generator 2 was de-energised and as a result the outlet temperature of the product gas fell rapidly to ambient temperature.

1. Apparatus for forming a product stream of hot gas at elevated pressure, comprising a plasma generator having an inlet for a primary gas stream at elevated pressure and an outlet for a resulting heated primary gas stream at elevated pressure, a gas mixing chamber for mixing the heated primary gas stream at elevated pressure with a secondary gas stream so as to form the product gas stream of hot gas at elevated pressure, a temperature controller for controlling the temperature of the said product stream, and a temperature sensor operatively associated with the temperature controller.

2. Apparatus according to claim 1, in which the temperature controller comprises a flow control valve for varying the flow rate of the secondary gas stream.

3. Apparatus according to claim 1 or claim 2, in which the temperature controller comprises a flow control valve for varying the flow rate of the primary gas stream.

4. Apparatus according to claim 2 or claim 3, in which the primary gas stream and the secondary gas stream come from a common source and a flow control valve is operable to select the relative flow rates of the primary gas stream and the secondary gas stream.

5. Apparatus according to any one of the preceding claims, in which the mixing chamber has a cooling jacket.

6. Apparatus according to claim 5, in which the cooling jacket is water-cooled.

7. Apparatus according to any one of the preceding claims, in which the temperature controller comprises a device for varying the plasma generator power.

8. Apparatus according to any one of the preceding claims, in which the temperature sensor is located in, near to or downstream of the outlet of the mixing chamber.

9. A method of forming a product stream of hot gas at elevated pressure, comprising passing a primary gas stream at elevated pressure through a plasma generator, operating the plasma generator so as to heat the primary gas stream, mixing the heated primary gas stream with a secondary gas stream so as to form the product stream of hot gas at elevated pressure, and controlling the temperature of the said product stream.

10. A method according to claim 9, in which the controlled gas outlet temperature of the product gas stream is in the range of 200° C. to 800° C.

11. A method according to claim 9 or claim 10, in which the primary gas stream comprises nitrogen, hydrogen, a noble gas, or a mixture of two or more of said gases.

12. A method according to claim 11, in which the noble gas is helium, argon or a mixture of helium and argon.

13. A method according to any one of the preceding claims, in which the product stream is formed at a pressure in the range of 1.1 bar to 30 bar.

14. A method according to any one of claims 9 to 13, in which the secondary gas has the same composition as the primary gas stream.

15. A method according to any one of claims 9 to 14, in which the secondary gas stream is introduced into the cooling chamber at a temperature in the range of 0° C. to 50° C.

16. A method according to any one of claims 9 to 15, wherein the temperature of the product stream of hot gas is controlled at a chosen but adjustable elevated temperature.

17. A method according to any one of claims 9 to 16, wherein the product stream of hot gas is passed to a cold gas dynamic spraying apparatus.
